(19) United States
(12) Patent Application Publication
(10) Pub. No.: US 2002/0105798 A1
(43) Pub. Date: Aug. 8, 2002

(54) Receptacle with decorative handle and light

(76) Inventor: Steven G. Hill, Menlo Park, CA (US)

Correspondence Address: TIMOTHY J MARTIN, PC, 9250 W 5TH AVENUE, SUITE 200, LAKEWOOD, CO, 80226, US

(21) Appl. No.: 09/778,848

(22) Filed: Feb. 8, 2001

(51) Int. Cl. F21W 131/00

(52) U.S. Cl. 362/156; 383/15

(57) ABSTRACT

A receptacle adapted to be carried by a person's hand during ambulatory activities is operative to receive items to be carried by the person. The receptacle is comprised of a container, a handle, and a light supported by the handle. The container has an interior and a mouth region to give a person access to the interior. The handle is secured to the container and adapted to be carried by a person's hand such that the container depends downwardly from the handle. The light supported by the handle is operative to emit light along a transmission axis such that when the handle is carried by the person's hand, and the container depends downwardly from the handle, the transmission axis is oriented obliquely to the path along the surface in front of the person

### FIELD OF THE INVENTION

The present invention relates generally to receptacles carried by a person for the purpose of collecting items. More particularly, the present invention concerns a bag that allows for the receiving and carrying of items placed therein by the person, and a handle affixed to the bag and used by the person for carrying the bag. The invention specifically concerns a bag with a handle and with a light supported by the handle to illuminate a path forwardly of the person while the person carries the bag during ambulatory activities.

### BACKGROUND OF THE INVENTION

Many people desire to carry a quantity of items in a convenient manner while using minimal physical effort and avoiding hindrances to their mobility. To this end, many typically place items to be carried into a receptacle that is simple to carry and provides easy hand access to the interior. Because people have a wide variety of items that they want to carry, receptacles exist in an array of styles, sizes, colors, and uses. Perhaps the most commonly used receptacle is the bag. Broadly, bags can encompass purses, backpacks, and duffel bags and can be made of fine leathers, nylon, or silk. Other bags can be simply shopping bags, grocery bags, garbage bags, and freezer bags.

Some bags are equipped with some type of handle to provide a simpler way to hold and carry the bag. Handles are usually either designed as an opening formed in the sidewall of the bag or separately affixed to the sidewall. Generally, handles are adapted to be engaged by the person's hand, but may also broadly include straps such as those worn on a person's shoulder, or across a person's back. Thus, handles typically reduce the both the physical effort needed to carry a bag, and the hindrances to a person's mobility to provide a convenient way for a person to carry items.

The need to carry items in a convenient and safe manner is especially important with respect to children. Since children are frequently in an exterior environment, they encounter many natural and artificial hazards such as uneven surfaces, wet or icy surfaces, darkness, vehicles, and various other obstacles. These hazards make it very important that the child remain attentive to his/her surroundings so as to reduce the risk of injury. However, a child's attentiveness can be complicated if the child carries an inconvenient bag. For example, a child's smaller size, and limited strength and endurance contribute to fatigue and impede the child's mobility.

One example of a circumstance where a child needs to be attentive to his/her surroundings is while carrying a treat bag during Halloween. The holiday of Halloween has become very popular worldwide, and millions of children participate in this festive occasion each year. As is customary, children dress in costumes and venture outdoors at night to collect candy in treat bags. Since trick or treating occurs at nighttime, it is especially important that the child be able to carry the treat bag in a convenient manner and not easily experience fatigue even when the bag is full of candy. Moreover, the added feature of darkness also makes it important that the child be able to see a path in front of him/her to avoid natural and artificial hazards. This can be especially important in certain geographical areas since Halloween is in the late fall season and there is a likelihood that snow and ice will be on the ground. Furthermore, since some costumes are dark in color or form a silhouette such that a child may not be easily seen at nighttime, it is also important that the child be visible to others. Thus, it is important that the child be able to easily carry a treat bag, while at the same time, carry a light so as to see in the dark and be visible to others.

One simple solution may be to have the child carry a flashlight. However, there are several problems with this solution. First, at least one of the child's hands will be used to hold the treat bag. Toward the end of the evening, the treat bag may even require both of the child's hands if it is full and heavy with candy. Second, adding an additional handheld object such as a flashlight may be too cumbersome for a child who is also holding costume accessories. Finally, awkward or bulky costumes may make it difficult to hold a flashlight and a treat bag. Thus, a handheld flashlight may be too cumbersome for a child to carry leading to fatigue or a restriction to the child's mobility and agility so as to compromise the child's safety.

Accordingly, there remains a need to provide a new and improved way for a child to carry a treat bag and obtain the safety benefits of a flashlight without sacrificing the child's mobility or agility. The ideal treat bag and lighting device would be easy to carry, even for those children wearing bulky costumes or holding costume accessories. Also, the ideal treat bag and lighting device would be inexpensive and easy to use while enhancing the child's safety. Finally, the ideal treat bag and lighting device would be aesthetically fitting with the theme of Halloween. The present invention satisfies these requirements.

### SUMMARY OF THE INVENTION

It is an object of the present invention to provide a new and useful receptacle that is adapted to receive items.

It is another object of the present invention to provide a new and useful receptacle that will illuminate a path forwardly of a person while being carried in the dark.

A further object of the present invention is to provide a receptacle that is easily carried by a child dressed in a costume, while at the same time allows the child to be visible at night.

Yet another object of the present invention is to provide a receptacle for use by a child during Halloween that is both lightweight and decorative.

Yet another object of the present invention is to provide a receptacle that is easily manufactured and inexpensive to purchase.

In accordance with these objectives, the present invention provides for a receptacle that is adapted to be carried by a person during ambulatory activities. Broadly, the receptacle comprises a container, a handle, and a light supported by the handle. Specifically, the container has an interior and mouth region with a handle secured to the container. When the handle is carried by a person's hand such that the container downwardly depends therefrom, the light supported by the handle is operative to emit light along a transmission axis oriented obliquely to a horizontal surface to illuminate a path along the surface in front of the person.

The container portion of the receptacle is a bag constructed of a pair of confronting panels and is made of a flexible material. The panels are connected to one another along a peripheral portion to form a mouth region and are movable between an open orientation and closed orientation. While in the open orientation, the panels are spaced apart to define an open interior and open mouth region so as to receive treats. While in the closed orientation the panels confront one another. The bag also includes indicia on an outer surface portion correlated to a Halloween theme bag such that it is decorative for a child to carry while trick-or-treating.

The handle portion is configured as a creature having an elongated body and adapted to be carried by the hand of a person or child. The handle may be in the form of any creature including a snake, worm, eel or octopus. The handle is preferably divided into two partible sections, a first handle section and a second handle section. Each section is a hollow shell formed of a translucent rigid material. Each section also includes at least one inner support rib located in the interior. The handle sections are movable between a first state and a second state. In the first state, the handle sections and the bag panels are in a confronting relationship, while in the second state, the handle sections and bag panels are spaced apart so as to define an open mouth region. While in the first state, the handle sections are joined by means of interlocking connector pieces. The second handle section provides a connector piece having a slot therein to receive and engage a portion of the inner support rib of the first handle section such that the free edges of the support ribs abut one another. The second handle section also includes a peg operative to engage a socket piece of the first handle section.

The handle is affixed proximate to the mouth region of the bag panels by mounting strips. The mounting strips are operative to connect a respective one of the handle sections to a respective one of the panel sections by tabs that extend from the mounting strip to engage a post on the handle section.

The handle portion also supports a light device. An end portion of the handle serves as an internal battery chamber that is sized and adapted to receive at least one battery. The battery chamber has a removable cap with a light therein and a window piece. The cap is operative to selectively enclose the battery chamber. The end portion of the handle also includes a switch that is movable to activate and deactivate the light. When the light is in the “on” state, it emits light along a transmission axis. This transmission is oriented obliquely to a horizontal support surface to illuminate a path along the surface in front of the person when the handle is engaged by a person's hand such that the bag depends downwardly therefrom.

These and other objects of the present invention will become more readily appreciated and understood from a consideration of the following detailed description of the exemplary embodiment of the present invention when taken together with the accompanying drawings, in which:

### BRIEF DESCRIPTION OF THE DRAWINGS

FIG. 1 is a perspective view of a receptacle, in the form of a bag, according to a first exemplary embodiment shown in a first state where the handle section of the bag panels confront one another;

FIG. 2 is a side view in an elevation, partially broken away, of the receptacle shown in FIG. 1;

FIG. 3 is an end view in elevation of the upper portion of the receptacle shown in FIGS. 1 and 2;

FIG. 4 is a perspective view of the upper portion of the receptacle of FIGS. 1-3 shown in a second state wherein the handle sections thereof and the bag panels thereof are spaced-apart to define an open mouthed region;

FIG. 5 is a side view in an elevation showing a first handle section and bag panel;

FIG. 6 is a side view in elevation showing a second handle section and a bag portion;

FIG. 7 is a cross-sectional view taken about lines 7-7 of FIG. 2;

FIG. 8 is a cross-sectional view taken about lines 8-8 of FIG. 2;

FIG. 9 is a side view exploded and in partial cross-section showing the head portion and light assembly according to the first exemplary embodiment of the present invention;

FIG. 10 is a cross-sectional view taken about lines 10-10 of FIG. 5; and

FIG. 11 is a side view in elevation of a top portion of a receptacle according to a second exemplary embodiment of the present invention.

### DETAILED DESCRIPTION OF THE EXEMPLARY EMBODIMENTS

The present invention is broadly directed to receptacles that may be used by a person to transport various items. More particularly, the present invention concerns a Halloween trick or treat bag that has a handle portion with a self-contained flashlight. Thus, when using the treat bag according to the preferred embodiment of the present invention, a child may move along a support surface with the treat bag suspended from the hand and light a pathway on that support surface during his/her ambulatory activities.

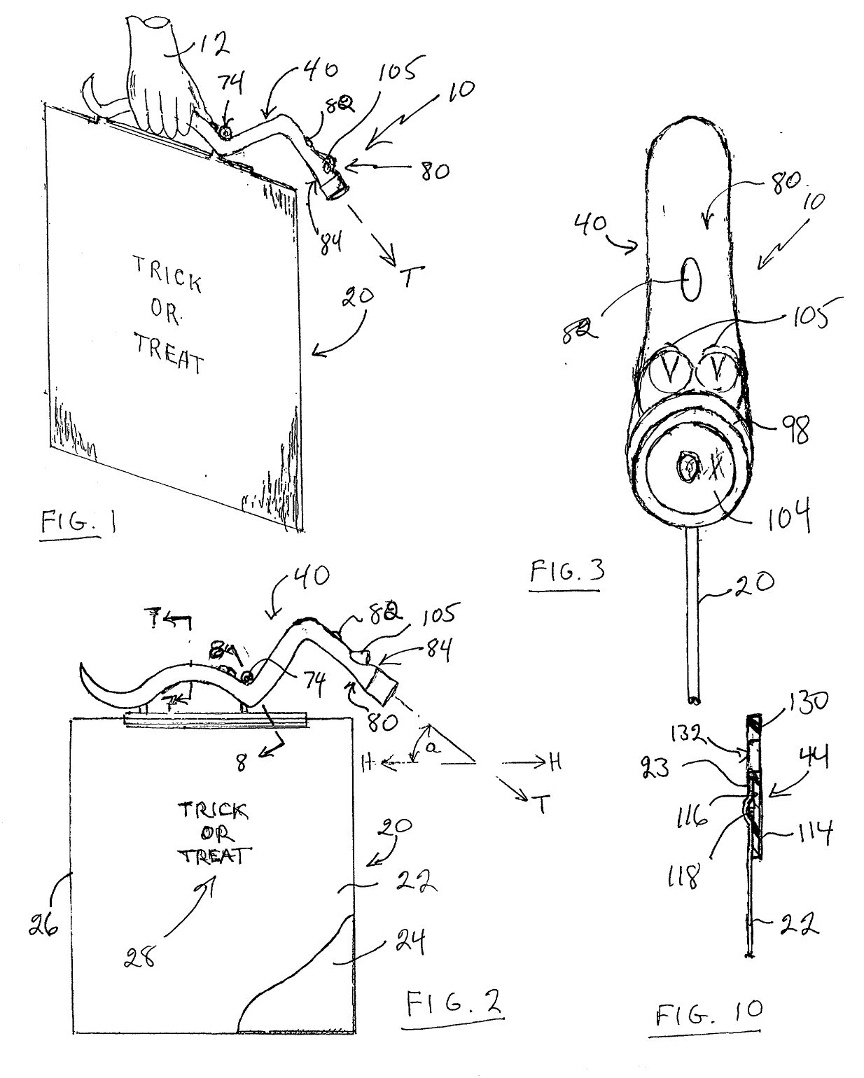

With reference, then, to FIG. 1, a first exemplary embodiment of a receptacle 10 according to the present invention is shown to include a container in the form of bag 20 and a handle 40 from which the bag is suspended. As is shown in FIG. 1, handle 40 has a mid-portion grasped by a person's hand 12 so that it can be held in a suspended relation. In FIG. 1, bag 20 is closed for convenient transport. As described more thoroughly below, handle 40 supports a light 80, and a switch 82 is provided to activate and deactivate the light.

With reference to FIGS. 2, 4 and 5, it may be seen that bag 20 is formed of a flexible material, such as cloth, plastic or the like. It is preferred that bag 20 be constructed of a translucent plastic material, such as polyethylene. Referring again to the Figures, it may be seen that bag 20 includes a flexible first panel 22 and a flexible second panel 24 that are preferably rectangular in configuration and that are joined along a majority of the periphery 26 thereof. The securing of the respective panels along the peripheral arch may be accomplished by any known technique in the bag making art. One or both of panels 22 and 24 may be provided with indicia, such as words 28, correlated to a Halloween theme.

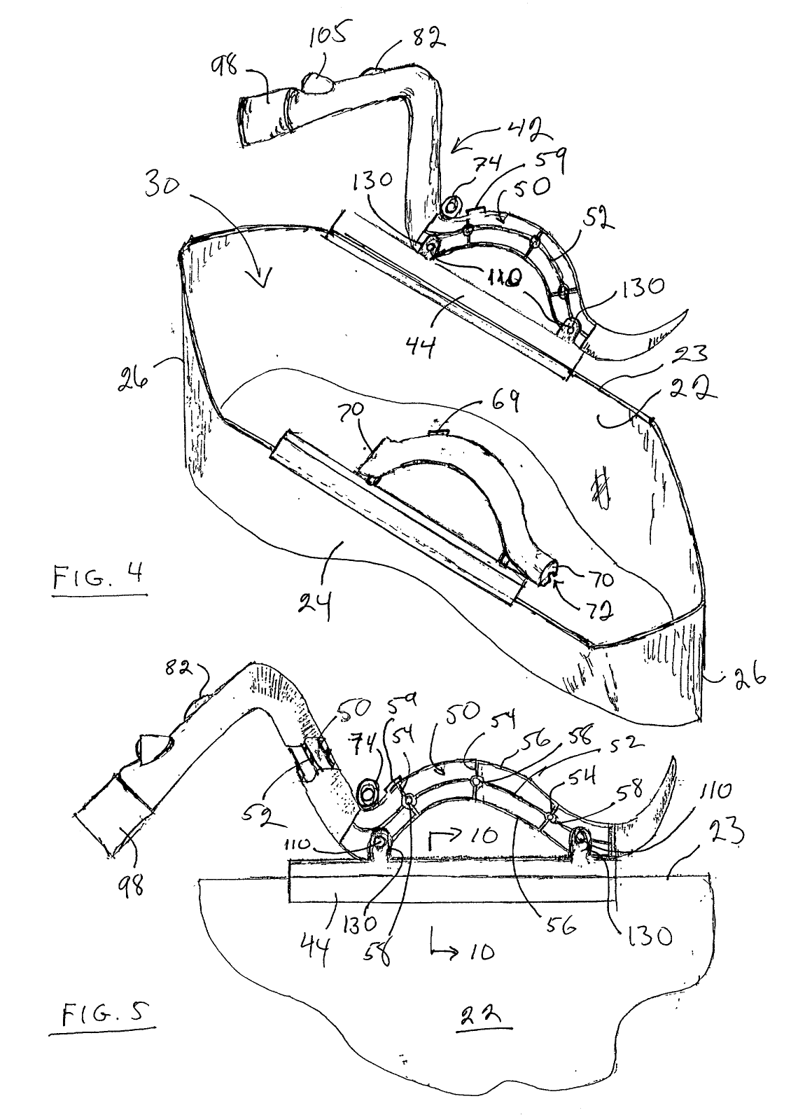

As is best shown in FIGS. 4-6 and as discussed below, handle 40 is configured as an elongated creature having two partible handle sections. A first handle section 42 is secured to first panel 22 by means of a flexible strip 44 along the upper edge 23 of first panel 22. Similarly, a second handle section 46 is secured to the upper edge 25 of second panel 24 by means of a flexible strip 48.

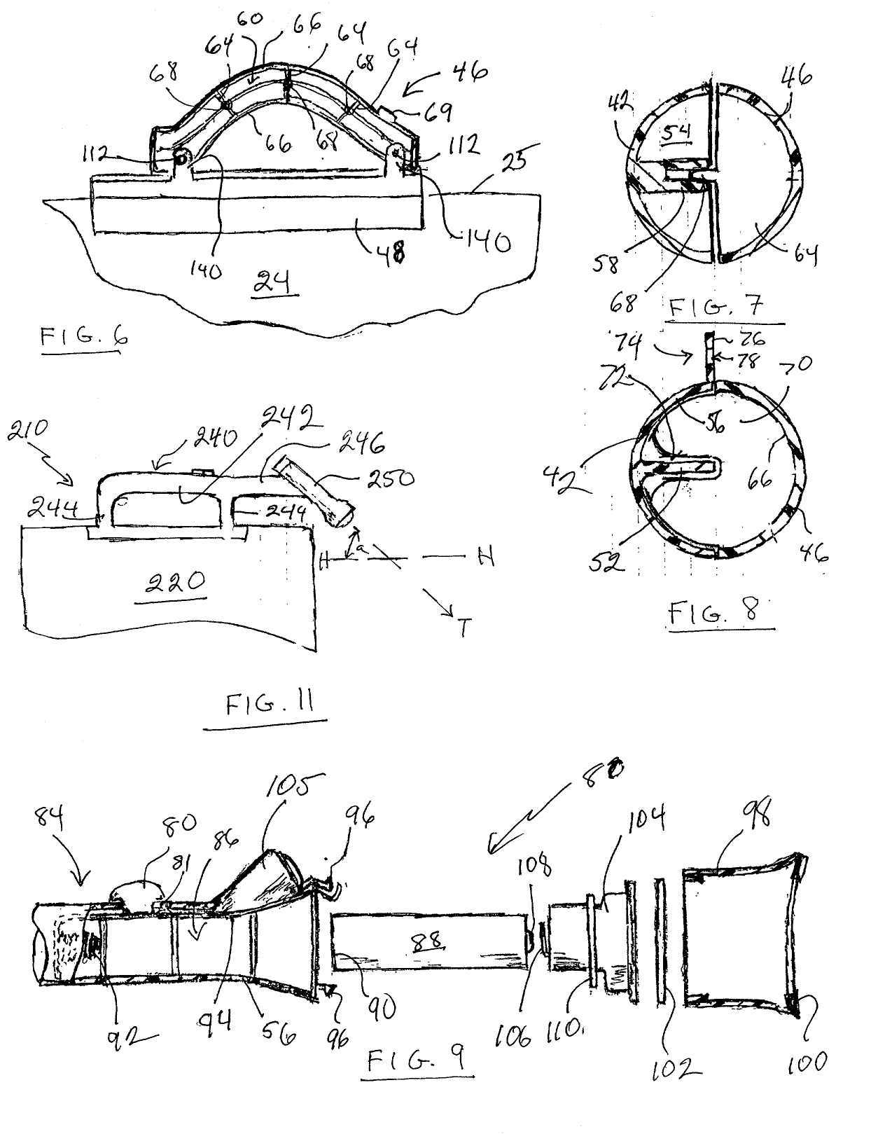

Turning to FIG. 4, it may be seen that first handle section 42 is preferably formed of a translucent plastic material having a hollow interior 50. Suitable plastics may be butadiene/styrene based polymers, GPPS is the preferred material. Interior 50 is reinforced at least one inner support rib, such as rib 52 extending longitudinally therein. Transverse webs 54 extend between side wall 56 with webs 54 having a socket 58 formed at the juncture between each web 54 and rib 52. In addition, as is also best shown in FIG. 8, first handle section 42 supports a connector ring 74 formed as an annular piece 76 having a central opening 78 therethrough. Annular piece 76 is connected at a circumferential edge to side wall 56 of first handle section 42. Connector ring 74 may be used to suspend receptacle 10 from a hook or other item, if desired. Ring 74 can be eliminated if desired.

Similarly, second handle section 46 has a hollow interior 60 that is provided with a reinforcing rib 62 extending longitudinally therein. Once again, rib 62 is intersected by a plurality of transverse webs 64 that extend between side wall 66 of second handle section 46. A peg 68 is located at the junction of transverse webs 64 and rib 62 which mates with socket 58 to releasably secure first handle section 42 and second handle section 46 together. Second handle section 46 also includes a pair of end webs 70 in the form of circular pieces each having a radial slot 72 formed therein. Each slot 72 is sized and configured to engage rib 52 in the interior 50 of first handle section 42 when placed in the first state. It may be noted that the edges of slot 77 are arcuate and radially diverge from one another. This helps guide the mating of the handle sections and facilitates registration of the creature's body.

As is shown in FIGS. 1-3, partible handle sections can be in a first state wherein the handle sections 42 and 46 are in confronting, mated relation and the bag panels 22 and 24 confront one another. However, as is best shown in FIG. 4, handles sections 42 and 44 are partible so that they may move into a second state wherein they are spaced-apart from one another and so that bag panels 22 and 24 are spaced-apart from one another so as to define an open mouth region 30. This allows the person access to the interior of bag 20. To facilitate separation of handle sections 42 and 46 from the confronting relation, finger tabs 59 and 69 are respectively provided thereon.

Handle 40 includes a light that is operative in an “on” state to emit light along a transmission axis “T”. Thus, as is shown in FIG. 1, when handle is carried by a person's hand the bag depends downwardly from the hand, the transmission axis will be oriented obliquely to a horizontal support surface, such as the ground, to illuminate a path in front of the person. This is illustrated with greater particularly in FIG. 2. Here, it may be seen that plane “H” is a horizontal plane intended to be parallel to the surface upon which a person walks. Transmission axis “T” is then oriented at an acute angle “a” with respect to the horizontal support surface as represented by plane “H”. Preferably, angle “a” is within a range of 25° to 45° with the preferred angle being 35°. In order to move the light between the “on” state and the “off” state, a slide switch 82 is provided to activate and deactivate the light.

The construction of light 80 is best shown in FIG. 9. Here, a first end portion 84 of handle 40 has an open internal battery chamber 86 sized and adapted to receive a battery 88 which has a first terminal 90 that makes electrical contact. Spring 92 is in electrical communication with an L-shaped connector 94 that may be reciprocated in the direction of arrow “X” upon sliding movement of switch 82 in slot 81. Side wall 56 diverges outwardly and is provided with a pair of prongs 96 which connect to a removable cap piece 98 that encloses chamber 86. To this end, cap piece 98 is generally cylindrical in configuration but has a radially inwardly projecting shoulder 100 against which a flat transparent plate 102 is positioned. Light 80 includes a bulb housing 104 provided with conductive ring 106 adapted to engage electrical contact 108 of battery 88. Housing 104 also supports a circumferential electrically conductive element 110 which contacts strip 94 when light 82 is the assembled state. This construction is generally known in the flashlight art.

Returning again to the connection of bag panels 22 and 24 to their respective strips 44 and 48, it may be first seen with reference to FIG. 5 that handle section 42 includes a pair of posts 110 formed in the interior 50 thereof. Similarly, with reference to FIG. 6, handle section 46 includes a pair of posts 112 formed in interior 60 thereof. With reference to these Figures as well as FIG. 10, it may be seen that each of flexible strips 44 and 48 is adhered to their respective bag panel. In FIG. 10, representative flexible strip 44 is shown adhered to the upper edge of bag panel 22. Strip 44 is a flexible plastic, such as polyethylene and includes a strip portion 114 having a channel 116 and an upstanding rib 118. The upper edge portion 23 of panel 22 may then be sealed against strip portion 114 in any suitable manner, such as adhesive, ultrasonic welding, other heat welding or the like. In any event, a pair of tabs, such as tab 130, projects upwardly from strip portion 114. Tab 130 includes an opening 132 sized to receive a respective post 110 in handle section 42. With reference, now, to FIG. 6, it may be seen that strip 48 includes tabs 140 for connection to posts 112. Strip 48 is constructed substantially identical to strip 44.

As noted above, it is preferred that the handle 40 of the present invention be constructed as an elongated item, preferably a form of an elongated creature that is correlated to the Halloween theme. Such creatures may include snakes, bats (with elongate wings), lizards, eels, etc., although it is to be understood that the present invention is not to be limited to just such creatures. Other animals or entities could be ghosts, aliens, dinosaurs, etc. In FIGS. 1-10, the selected creature is a snake with eye features 105 formed on first handle section 42 proximally to cap 98. Cap 98 and reflective bulb housing 104 form the appearance of the mouth for a snake. When handle sections 42 and 46 are secured together, they then form a complete body for the snake, as is best shown in FIG. 1.

Another embodiment of the present invention is shown in FIG. 11. Here, receptacle 210 is shown in the form of a handle having a gripping portion 242 and a pair of downwardly projecting legs 244 that are connected to container or bag 220. A neck portion 246 projects linearly with gripping portion 244 and supports a flashlight 250. Flashlight 250 in its light along a transmission axis “T” that is again oriented at an oblique angle “a” to the horizontal surface represented by plane “H”. Handle 240 could be configured, as desired, to represent other animal shapes. For example, downwardly depending legs 244 could represent the legs of the animal with gripping portion 242 and neck 246 being configured into the torso and neck area of the animal. Flashlight 250 could then be configured into the head of the animal. All of this is believed to be within the ability of the ordinarily skilled artisan based upon the teachings of this present application. It should be understood that the gripping portion and the legs do not need to be a part of a creature's body. Rather, flashlight 250 could take the form of a human head (such as a witch or a vampire), an animal's head or even an object such as a pumpkin.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiment of the present invention without departing from the inventive concepts contained herein.

I claim:

1. A receptacle adapted to be carried by a person's hand during ambulatory activities and operative to receive items carried by the person, wherein the person moves in a forward direction of travel along a support surface, comprising:
(a) a container having an interior and a mouth region, said mouth region operative to give the person access to the interior;
(b) a handle secured to the container and adapted to be carried by a person's hand such that the container downwardly depends therefrom; and
(c) a light supported by the handle and operative in an “on” state to emit light along a transmission axis such that when the handle is carried by a person's hand and the container depends downwardly therefrom, the transmission axis is oriented obliquely to a horizontal support surface to illuminate a path along the surface in front of the person.

2. A receptacle according to claim 1 wherein said container is a bag constructed of flexible material.

3. A receptacle according to claim 2 wherein said bag includes two confronting panels.

4. A receptacle according to claim 1 wherein said handle is configured as a creature.

5. A receptacle according to claim 4 wherein said creature is selected from a group consisting of: snakes, bats, lizards, eels, etc.

6. A receptacle according to claim 4 wherein said creature has an elongated body.

7. A receptacle according to claim 1 wherein said handle has a hollow interior and is formed of a rigid material, said handle being reinforced by at least one inner support rib located in the interior thereof.

8. A receptacle according to claim 1 wherein said handle is formed of a translucent material.

9. A receptacle according to claim 1 wherein one end of said handle has an internal battery chamber located thereof and is sized and adapted to receive at least one battery, said one end including a removable cap with a window piece therein and operative to selectably enclose the battery chamber.

10. A receptacle according to claim 9 wherein said light is disposed within said removable cap.

11. A receptacle according to claim 10 including a switch disposed on said handle and movable between a first switch position operative to place said light in the “on” state and a second switch position operative to deactivate said light.

12. A receptacle adapted to be carried by a person's hand during ambulatory activities and operative to receive items carried by the person, comprising:
(a) a flexible bag having a pair of facing panels connected to one another along a peripheral portion to form an interior and a mouth region communicating with the interior thereby to give the person access to the interior;
(b) a handle including two partible handle sections wherein a first handle section is secured to a first bag panel and a second handle section is secured to a second bag panel, said partible handle sections movable between a first state wherein the handle sections and the bag panels are in a confronting relationship, and a second state wherein the handle sections and the bag panels are spaced apart so as define an open mouth region; and
(c) a light supported by the handle and operative in an “on” state to emit light along a transmission axis.

13. A receptacle according to claim 12 including a mounting strip respectively affixed to each panel proximately to the mouth of said bag, each of said strips operative to connect a respective one of said handle sections to a respective one of said panels.

14. A receptacle according to claim 13 wherein each said handle section includes a post and each of said mounting strips includes a tab that extends therefrom, each said tab operative to engage a respective post.

15. A receptacle according to claim 12 wherein said handle is a creature.

16. A receptacle according to claim 12 wherein each said handle section is a shell formed of a rigid material with a hollow inner region and a support rib disposed in said inner region.

17. A receptacle according to claim 16 wherein said second handle section includes a pair of end webs each having a slot therein, each said end web while in the first state operative to engage a portion of said inner support rib of said first handle section such that the free edges of said support ribs abut one another.

18. A receptacle according to claim 16 wherein said inner rib of said second handle section includes a peg, said peg operative to engage a socket piece of said first handle section.

19. A receptacle according to claim 12 wherein said transmission axis is oriented obliquely to a horizontal support surface to illuminate a path along the surface in front of the person when said handle is engaged by the person's hand when walking in a forward direction.

20. A Halloween treat bag adapted to be carried by a child during Halloween activities and operative to receive treats to be carried by the child, comprising:
(a) a container formed of two flexible panels sealed around a majority of the perimeter thereof to form a mouth region, said container movable between an open orientation wherein said panels are spaced apart from one another to have an open interior so as to receive treats, and a closed orientation wherein said panels confront one another;
(b) a handle configured as a creature having two partible handle sections, wherein a first handle section is secured to a first one of flexible panels, and a second handle section is secured to second panel such that the container downwardly depends from the handle when carried in the hand of a child; and
(c) a light disposed in an end portion of the handle and operative in an “on” state to emit light along a transmission axis.

21. A Halloween treat bag according to claim 20 includes indicia on an outer surface portion of said container, said indicia correlated to a Halloween theme.

22. A Halloween treat bag according to claim 20 wherein said creature is selected from a group consisting of: snakes, bats, lizards, eels, etc.

23. A Halloween treat bag according to claim 20 where in said creature is elongated.

24. A Halloween treat bag according to claim 20 wherein said creature has a mouth and wherein said light is received in said mouth.

25. A Halloween treat bag according to claim 20 wherein said handle is formed of a translucent material.

26. A Halloween treat bag according to claim 20 wherein said transmission axis is oriented obliquely to a horizontal support surface to illuminate a path along the surface in front of the child when said handle is engaged by the child's hand when walking in a forward direction.

27. A method of illuminating a path of travel for a person during ambulatory activities while the person moves in a forward direction along a horizontal support surface, comprising the steps of:
(a) providing a receptacle which includes a container having an interior adapted to receive items carried by the person, a handle adapted to be grasped by the person's hand, and a light supported by the handle, said light being operative in an “on” state to emit light along a transmission axis;
(b) grasping the handle of said receptacle in a such a manner that said container depends downwardly from said handle when said person is in an upright position and said transmission axis is oriented obliquely to the horizontal support surface; and
(c) placing said light in the “on” state thereby to illuminate the path of travel.
